(19) United States
(12) Patent Application Publication
(10) Pub. No.: US 2025/0230177 A1
(43) Pub. Date: Jul. 17, 2025

(54) PHOSPHATE ESTERS WITH VERY LOW TRIPHENYL PHOSPHATE

(71) Applicant: Polymer Additives, Inc., Independence, OH (US)

(72) Inventors: Hongqiao Wu, Broadview Heights, OH (US); Jiannong Xu, Mayfield Village, OH (US)

(21) Appl. No.: 18/976,548

(22) Filed: Dec. 11, 2024

Related U.S. Application Data
(60) Provisional application No. 63/620,943, filed on Jan. 15, 2024.

(51) Int. Cl. C07F 9/09; C08K 5/52

(52) U.S. Cl. CPC C07F 9/09; C08K 5/52

(57) ABSTRACT

A composition includes phosphate esters, such as alkyl and aryl phosphate esters, with very low to no triphenyl phosphate (TPP) contents. Methods to synthesize phosphate esters with the goal of controlling TPP to be less than 0.1%, sharply reducing the potential toxicity of products including phosphate esters, are also disclosed.

### CROSS-REFERENCE TO RELATED APPLICATIONS

This application claims priority to U.S. provisional application No. 63/620,943, filed on Jan. 15, 2024. That prior application is incorporated herein by reference.

### BACKGROUND

Phosphate esters are widely used for their flame retardant properties with main applications as additives in wire and cable formulations. Phosphate esters may be non-halogenated, and these types are growing to replace brominated flame retardants.

Triphenyl phosphate (CAS No. 115-86-6) is a well-known phosphate ester flame retardant, but one that has an expanding regulatory regime. European regulatory bodies increased its risk evaluation in 2017. France published its conclusion document in May 2023 indicating that triphenyl phosphate (TPP) should be a category 1 classification for endocrine disruption and it was recommended to be added to the list of SVHC (substance of very high concern). This is a first step for the substance to be restricted for commerce. TPP was officially put on the list of SVHC by a European authority in early November 2024.

Even if not present in products intentionally, TPP is a by-product in the synthesis of other phosphate esters. It is difficult or impossible to remove by techniques employed after synthesis.

### SUMMARY

The following is a brief summary of subject matter that is described in greater detail herein. This summary is not intended to be limiting as to the scope of the claims.

Disclosed herein is a composition comprising phosphate esters, such as alkyl and aryl phosphate esters, with very low to no TPP contents. Methods to synthesize phosphate esters with the goal of controlling TPP to be less than 0.1%, sharply reducing the potential toxicity of these products are also disclosed.

In some aspects, the techniques described herein relate to a composition including: phosphate ester compounds of formula 1, formula 2, and formula 3

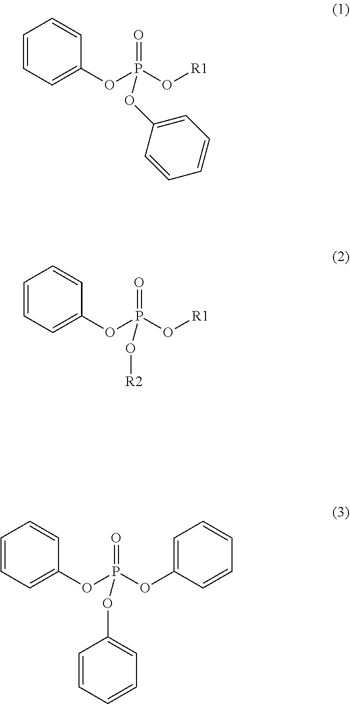

wherein R1 and R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof; wherein formula 1 is 75% or more by weight/total weight of all phosphate esters in the composition; and formula 3 is less than 0.1% by weight/total weight of all phosphate esters in the composition; or
phosphate ester compounds of formula 4, formula 5, and formula 3;

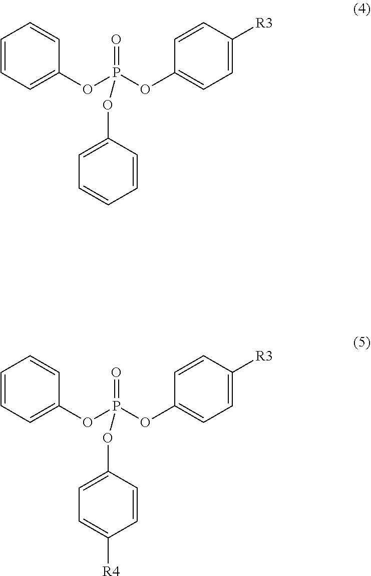

wherein R3 and R4 are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof, and formula 3 is less than 0.1% by weight/total weight of all phosphate esters in the composition

In some aspects, the techniques described herein relate to a polymer composition including: (a) a polymer selected from the group consisting of polyvinylchloride (PVC), polyurethane, polyvinyl acetate, polyvinyl butyral, polystyrene, nitro-cellulose, nitrile rubber, ABS, polycarbonate, polyamide, polyester, epoxy, and combinations thereof; and (b) a phosphate ester composition including phosphate ester compounds of formula 1, formula 2, and formula 3 as listed above, wherein R1 and R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof; wherein formula 1 is 75% by weight/total weight of all phosphate esters in the composition; and formula 3 is less than 0.1% by weight/total weight of all phosphate esters in the composition. or phosphate ester compounds of formula 4, formula 5, and formula 3, each as listed above, wherein formula 3 is less than 0.1% by weight/total weight of all phosphate esters in the composition.

In some aspects, the techniques described herein relate to a method of making a phosphate ester with low triphenyl phosphate content, the method including: reacting an alcohol having the formula R₀OH with POCl₃ to produce a reaction mixture with an intermediate; wherein the alcohol having the formula R₀OH is provided at a ratio of ≥1.10 to 1 of the POCl₃ by mole ratio; wherein R₀ is an alkyl group selected from the group consisting of: C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof; reacting the intermediate with a phenate compound to form a composition including a phosphate monoester including an alkyl group corresponding to R₀; or
reacting a substituted phenol with POCl₃ wherein the phenol is substituted with an substitute group R₃ and/or R₄; wherein the substituted phenol is provided at a molar ratio of ≥1.65:1 of the substituted phenol to POCl₃; wherein R₃ and R₄ are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### DETAILED DESCRIPTION

Various technologies pertaining to a triphenyl phosphate with very low content of triphenyl phosphate (TPP) are now described. In the following description, for purposes of explanation, numerous specific details are set forth in order to provide a thorough understanding of one or more aspects. It may be evident, however, that such aspect(s) may be practiced without these specific details.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Where a molecular weight is provided, for example, of a polymer, then the molecular weight should be understood to be an average molecule weight, unless otherwise stated or understood from the context.

Triphenyl phosphate (TPP) is a by-product in most alkyl aryl phosphates and triaryl phosphate commercial products. Some commercial products were tested herein by gas chromatography methods to determine the amount of TPP %. For products on the market, the amount of TPP varies from 40% to about 1%. Considering the fact that the TPP percentage is enough to be added to the SVHC list, it was determined that there was a need to reduce TPP % in the alkyl aryl phosphates and triaryl phosphates.

The phosphate ester compositions disclosed herein may include various alkyl aryl phosphate esters. In an embodiment, the phosphate ester includes one or more of compounds of Structure 1 and 2.

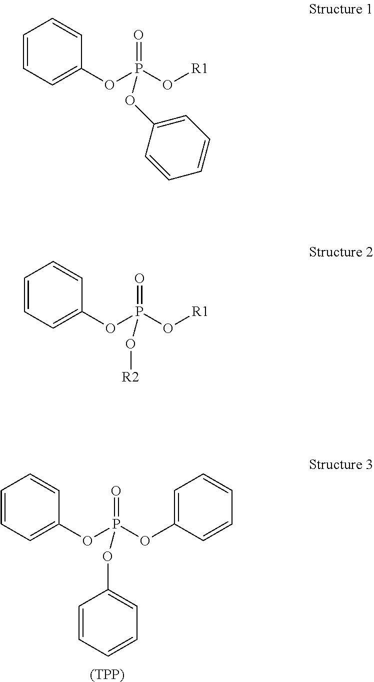

In structures 1 and 2, R1, R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof. The C4-C18 alkyl groups, C4-C18 alkenyl groups, C4-C18 alkoxy groups, C4-C18 hydroxyalkyl groups, can be selected from, e.g., C5-C16, C6-C14, or C8-C12.

In particular embodiments, R1 and R2 are independently selected from C4-C18 alkyl groups or C4-C18 alkylether groups. In other embodiments, R1 and R2 are independently selected from linear or branched C8 groups, such as 2-ethylhexyl, or C10 groups such as isodecanol. In other embodiments, R1 and R2 are independently selected from the group consisting of linear or branched C12, C14, or C16 groups, or R1 and R2 are independently selected from the group consisting of 2-ethylhexyl, linear or branched-C₁₀H₂₁, —C₁₂H₂₅, —C₁₄H₂₉, or —C₁₆H₃₃ groups; or R3 and/or R4 are t-butyl groups.

Particular examples of phosphate esters corresponding to structure 1 are 2-ethylhexyl diphenyl phosphate, (CAS Number 1241-94-7), isodecyl diphenyl phosphate, (CAS Number is 29761-21-5), C12-C16 alkyl diphenyl phosphate.

In an embodiment, the phosphate ester is non-halogenated, such as, non-brominated and non-chlorinated. In an embodiment, the phosphate ester has a molecular weight of 650 g/mol to 325 g/mol, such as, for example, 520 g/mol to 350 g/mol, or 480 g/mol to 390 g/mol.

In an embodiment, the phosphate ester composition has a content of ≥75% of structure 1 by weight/total weight of formula 1, formula 2, and formula 3 (or total weight of the composition), such as 76% to 99.9%, 80% to 95%, or 85% to 90% of structure 1. Structure 2 may be present in at 24.999% to 0.0001% by weight/total weight of formula 1, formula 2, and formula 3 (or total weight of the composition), such as 20% to 1%, or 15% to 5%.

In an embodiment, the phosphate ester includes one or more substituted triphenyl phosphate compounds of Structure 4 and 5, wherein one or two of the phenyl groups are substituted with a substituent R3, R4.

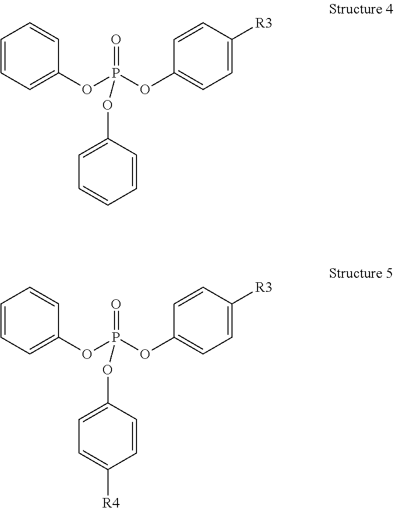

In structures 4 and 5, the substituent groups R3 and R4 are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof. The number of carbon atoms in the C1-C10 alkyl groups, C1-C10 alkenyl groups, C1-C10 alkoxy groups, and/or C1-C10 hydroxyalkyl groups, can be selected from, e.g., C2 to C9, C3 to C7, or C4 to C6. In a particular embodiment, R3 and/or R4 are t-butyl groups.

In an embodiment, the substituted triphosphate ester compound is non-halogenated, non-brominated, or non-chlorinated. In an embodiment, the phosphate ester has a molecular weight of 700 g/mol to 375 g/mol, such as, for example, 620 g/mol to 400 g/mol, or 450 g/mol to 420 g/mol.

In an embodiment, the substituted triphenyl phosphate composition has a content of ≥40% of structure 4 by weight/total weight of formula 4, formula 5, and formula 3, total weight of all phosphate esters (or total weight of the composition), such as 55% to 85%, 60% to 80%, or 65% to 75% by weight of structure 4. Structure 5 may be present in an amount of 60% to 0.0001%, such as 50% to 1%, or 40% to 5%.

In either composition containing structures 1 and 2 or structure 4 and 5, the phosphate ester compositions have traditionally had contents of 0.5 to 3% of Structure 3 (TPP). In contrast, the phosphate ester compositions disclosed herein have total TPP weight percent less than 0.1% by weight of TPP/total phosphate ester weight, such as each of formulas 1-5, or total composition weight, such as, for example, 0.0001% to 0.09%, 0.001% to 0.08%, 0.01% to 0.05%, or 0.015 to 0.045%.

The phosphate ester composition may also contain very small amounts of phenol and water, e.g., 1 to 500 ppm, such as 10 to 300 ppm of each.

Several consumer and industrial products may include the phosphate ester composition as a component. For example, flame retardant materials utilize the phosphate ester as a flame retardant and polymeric materials may use phosphate esters as plasticizers. In some applications, phosphate esters act as both plasticizers and flame retardants.

In particular, phosphate esters that are non-halogenated are valued for use in flame retardant materials. The phosphate ester works by causing a covering or smothering effect in the solid phase of burning materials. Upon exposure to heat from a fire, the phosphate ester reacts to form a polymeric form of phosphorous acid. The heat-activated polymeric phosphorous acid causes a char layer to cover the burning material, blocking it from contact with oxygen. This slows down or stops the combustion reaction.

Phosphate esters can be used in polymeric compositions such as, for example, polyvinylchloride (PVC), polyurethane, polyvinyl acetate, polyvinyl butyral, polystyrene, nitro-cellulose, nitrile rubber, ABS, polycarbonate, polyamide, polyester, epoxy, and combinations thereof. The phosphate ester provides a plasticizing effect and can also be used to improve fire resistance and/or smoke suppression of the material. Plasticizers can be used to improve processing characteristics and end properties of the material. Materials such as wire, cable, flooring, textiles (polymer coated fabric), belts, hoses, structural foams, paint, coatings, oils, and lubricants may benefit from the phosphate ester compositions disclosed herein.

In an embodiment, the phosphate ester composition is contained in a material, which has a total TPP weight percent of less than 0.1% (weight of TPP/total phosphate ester weight), such as, for example, 0.0001% to 0.09%, 0.001% to 0.08%, or 0.01% to 0.05% (weight of TPP/total phosphate ester weight). In addition, the total TPP weight percent of in the polymeric material is less than 0.1% (weight of TPP/total material weight), such as, for example, 0.0001% to 0.09%, 0.001% to 0.08%, or 0.01% to 0.05% (weight of TPP/total material weight).

In an embodiment, 2-ethylhexyl diphenyl phosphate is synthesized in a three-step reaction. In the first step, the starting raw materials are POCl₃ and 2-ethylhexanol. These fluids are mixed together and 2-ethylhexanol is provided in excess by 10% or more. The stoichiometric ratio between 2-ethylhexanol to POCl₃ is ≥1.10, such as, for example, 1.10 to 2, or 1.11 to 1.5, or 1.2 to 1.3. In an embodiment, the reaction is cooled below room temperature, e.g., 1 to 22° C., such as 5 to 15° C., or 8 to 12° C. Cooling may be applied during the reaction and/or the reactants may be metered to keep the reaction temperature low, e.g., 1 to 20° C., such as, 8 to 18° C. or 12 to 16° C. Partial vacuum may also be applied to the reaction flask as it progresses, e.g., a pressure of 10 to 75 mmHg, such as, 20 to 60 mmHg or 30 to 50 mmHg.

In prior methods of making this compound, the ratio was equal or in slight excess, e.g., by a factor of 1.0-1.05. Surprisingly, this small change in the ratio of these components made an unexpected improvement in reducing the TPP side-product to less than 0.1% by weight.

Another unexpected process improvement was made in extending the holding time at the end of the step 1 reaction to ≥15 minutes. This is in contrast to the prior practice which was holding for only 0-5 minutes. By holding time it is meant, the time after all reactant has been added. Holding may also include mixing or agitation. Reduction in the TPP content was discovered by lengthening this step. After mixing the two components, the reaction may be held for ≥15 minutes, such as 15.5 to 60 minutes, 16 to 25 minutes, or 17.5 to 22.5 minutes. For the time the reaction mixture is held, it may be temperature controlled to, e.g., 1 to 20° C., such as 5 to 15° C., or 8 to 12° C. Extending the hold time allows as much POCl₃ molecules as possible to react with the alcohol. At lower temperature, e.g., 8 to 18° C. or 12 to 16° C., this reaction is favored. Once POCl₃ is reduced to a very small amount, TPP % can be controlled to be less than 0.1%. This is because it is believed that POCl₃ entering Step 3 reaction is the chemical that reacts to make TPP.

In some embodiments, the reaction mixture may be held for a further time, such as 15.5 to 60 minutes, 16 to 25 minutes, or 17.5 to 22.5 minutes, and/or can be further held under partial vacuum and warming to e.g., 28 to 45° C., such as 30 to 40° C., or 33 to 38° C. This step is to further complete the reaction between all the raw materials.

At this stage, the mono-ester between POCl₃ and the alcohol is predominantly the species. There is a slight amount of di-ester due to the excess of the alcohol. This piece at relatively higher temperature is to use up all the raw materials before entering the Step 3 reaction.

### Step 1 is Depicted in Reaction Scheme (Ia)

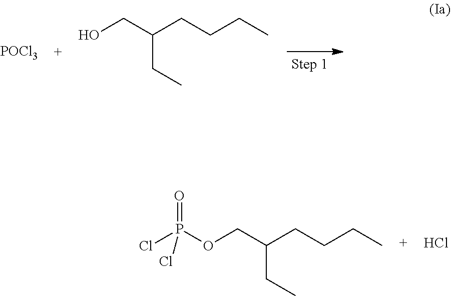

In step 1, sufficient excess of alcohol should be provided and the hold time at the end of step 1 should be long enough and at a low enough temperature to allow POCl₃ molecule to react with the alcohol and form the mono-ester. Without being bound to theory it is believed that these reaction conditions promote removal of unreacted POCl₃ molecules from entering step 3 where they may react with sodium phenate. Any unreacted POCl₃ molecules are likely to react at step 3 and become TPP.

If the reaction is raised to higher temperature too soon at the end of the step 1 reaction, those already formed mono-esters (namely, dichloridate) can react further with the free alcohol and consume all of it. This deprives the remaining POCl₃ molecules the chance to become mono-ester and adds to the formation of TPP in the step 3 reaction.
Step 2 is depicted in reaction scheme (Ib). Sodium hydroxide (NaOH) is added to phenol. This produces an intermediate product, a sodium phenate compound, and water.

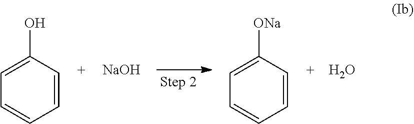

This reaction may be cooled, for example, to keep it under 50° C., such as 45° C. to 35° C., or 42° C. to 38° C.
Step 3 is depicted in reaction scheme (Ic). The intermediate sodium phenate compound from step 2 is combined with the intermediate product of step 1, which is 2-ethylhexyl dichloro-phosphate, (Ic). The sodium phenate is provided in a molar ratio of 2:1 to the 2-ethylhexyl dichloro-phosphate. This produces the 2-ethylhexyl diphenyl-phosphate end product along with sodium chloride salt. Very little TPP is produced in the final product through these steps 1-3 and reaction schemes (Ia, Ib, Ic) when conducted in accordance with conditions listed above with respect to excess alcohol and/or long holding time after step 1.

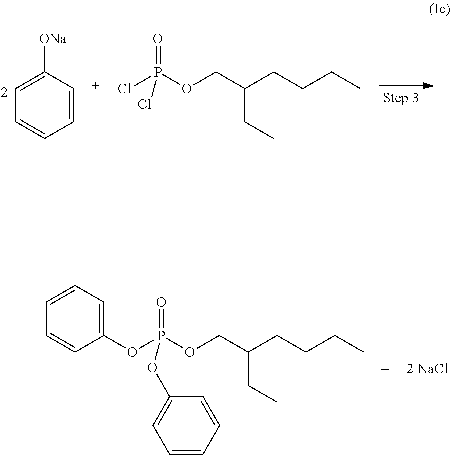

In an embodiment, water and base may be mixed and cooled to 20° C. before adding phenol such that the temperature of the step 3 reaction may be controlled, for example, to keep it under 50° C., such as 45° C. to 35° C., or 42° C. to 38° C.

In an embodiment, at the end of the Step 3 reaction, water may be added and then HCl to adjust the pH of the system to, for example 9 to 12, such as 9.5 to 11.5, or 10 to 11.

In an embodiment, isodecyl diphenyl phosphate ester is similarly produced in a three-step reaction. The same temperature ranges listed above for the reaction steps of the 2-ethylhexyldiphenyl phosphate ester embodiment are applicable to the isodecyl diphenyl phosphate ester embodiment.

In the first step, the starting raw materials are POCl₃ and isodecanol. These fluids are mixed together and isodecanol is provided in excess by 10% or more. The stoichiometric ratio between isodecanol to POCl₃ is ≥1.10, such as, for example, 1.10 to 2, or 1.11 to 1.5, or 1.2 to 1.3.

In prior methods of making this compound, the ratio was equal or in slight excess, (1.0-1.05). Surprisingly, this small change in the ratio of these components made an unexpected improvement in reducing the TPP side-product to less than 0.1% by weight. HCl is produced as the main byproduct.

After mixing the two components, the reaction is held for ≥15 minutes, such as 15.5 to 60 minutes, 16 to 25 minutes, or 17.5 to 22.5 minutes. For the time the reaction mixture is held, it may be temperature controlled to, e.g., 1 to 20° C., such as 5 to 18° C., or 12 to 15° C. This produces a first intermediate product. Step 1 is depicted in reaction scheme (IIa).

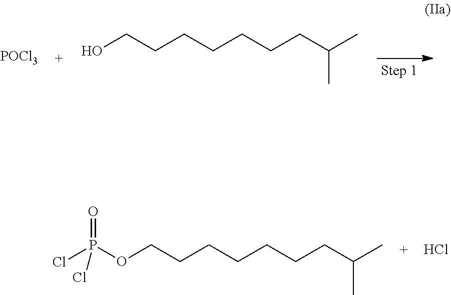

Similar to reaction scheme Ia, the process was improved by extending the holding time at the end of the step 1 reaction to ≥15 minutes. Further reduction in the TPP content was discovered by lengthening this step.
In step 1, sufficient excess of alcohol should be provided and the hold time at the end of step 1 should be long enough and at a low enough temperature to allow the POCl₃ to react with the alcohol and form the mono-ester. Without being bound to theory, it is believed that these reaction conditions promote removal of unreacted POCl₃ molecules from entering step 3 where they may react with sodium phenate. Any unreacted POCl₃ molecules are likely to react at step 3 and become TPP.

If the reaction is raised to higher temperature too soon at the end of the step 1 reaction, those already formed mono-esters (namely, dichloridate) can react further with the free alcohol and consume all of it. As in the previously described reaction, it is believed that this deprives the remaining POCl₃ molecules the chance to become mono-ester and adds to the formation of TPP in the step 3 reaction.
Step 2 is depicted in reaction scheme (IIb) and is the same as Ib above. Sodium hydroxide (NaOH) is added to phenol. This produces a sodium phenate compound and water.

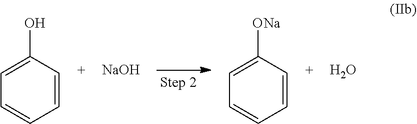

Step 3 is depicted in reaction scheme (IIc), the sodium phenate compound from step 2 is combined with the product of step 1, isodecyl dichloro-phosphate, (IIc). This produces the isodecyl diphenyl-phosphate end product along with sodium chloride salt. Very little TPP is produced in the final product through these steps 1-3 and reaction schemes (IIa, IIb, IIc) when conducted in accordance with conditions listed above with respect to excess alcohol and/or long holding time after step 1.

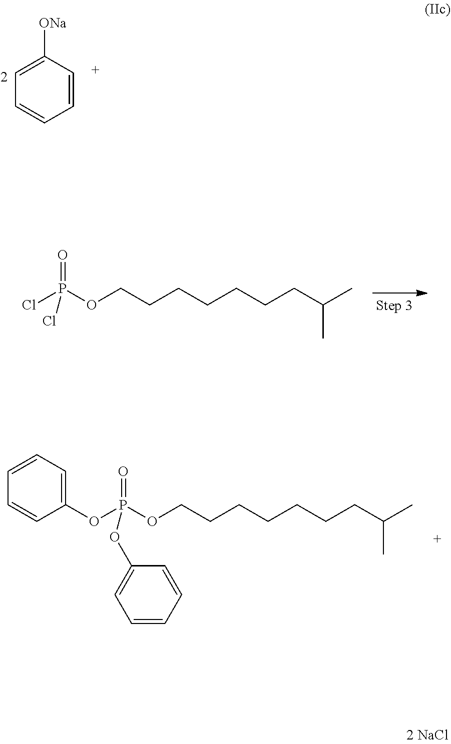

The process steps recited above for particular phosphate ester end products can be applied to other embodiments where an alcohol is added in step 1 at ≥1.10 to 1 POCl₃ by mole ratio, or other ratios recited above. The alcohol (R₀OH) can have an R₀ group selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof. The C4-C18 alkyl groups, C4-C18 alkenyl groups, C4-C18 alkoxy groups, C4-C18 hydroxyalkyl groups, can be selected from, e.g., C5-C16, C6-C14, or C8 to C12.

To continue the synthesis, steps 2 and 3 are conducted as recited above with the intermediate product from step 1 being added in step 3 to the phenate intermediate product of step 2 as recited above. Bases other than NaOH can be used, such as KOH.

In each of the above synthesis steps, the reaction mixture after step 3 undergoes isolation (removal of an oil-product layer) and purification steps (e.g., washing) to arrive at the phosphate ester composition.

In an embodiment, an substituted triphenyl phosphate is synthesized in a two-step single vessel reaction illustrated in reaction scheme (III).

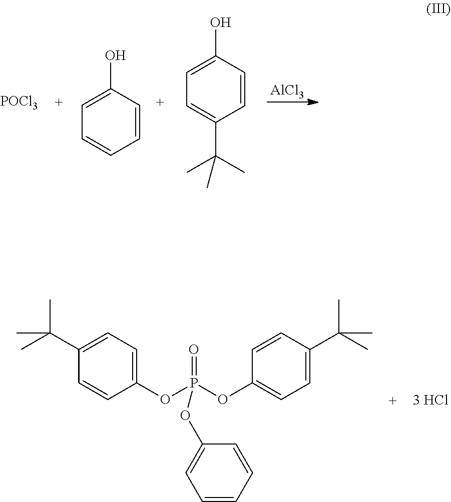

In the first step, the starting raw materials are POCl₃, aluminum chloride (AlCl₃), and p-tert-butyl-phenol (PTBP). The POCl₃/AlCl₃ are present first in the reaction vessel followed by additional of PTBP, and preferably are heated, e.g., to 50 to 95° C., such as 55 to 85° C., or 65 to 75° C. The aluminum chloride acts as the catalyst and may be provided in a small amount e.g., 1:100 to 1:10 molar ratio with the POCl₃, such as, 1:80 to 1:20, or 1:40 to 1:60 molar ratio.

Then the mixture of POCl₃/AlCl₃ is heated at a second temperature for some time, e.g., 30 minutes to 24 hours, such as 1 hour to 4 hours, or 1.5 hours to 3 hours. The second temperature may be 100 to 200° C., such as 110 to 150° C., or 115 to 135° C.

After this further heating, phenol is added at the second temperature to the mixture and the second temperature is maintained for a time period, e.g., 1 to 5 hours, such as 2 to 4 hours, or 2.5 to 3.5 hours. After this time period, a partial vacuum may be applied for a second time period to the reaction flask, e.g., at a pressure of 20 to 85 mmHg, 30 to 70 mmHg, or 40 to 60 mmHg. The second time period may be, e.g., 0.25 to 2 hours, such as, 0.5 to 1.5 hours, or 0.4 to 0.75 hours. The second temperature may be maintained for the second time period. After this second time period, the reaction is cooled, to a temperature less than the second temperature, e.g., 25 to 100° C., 40 to 90° C., or 50 to 85° C.

More reactants are then added in a second step. First, a caustic base, e.g., NaOH, or KOH is added. This base may be diluted in water and its function is to neutralize the catalyst, aluminum chloride. Then optionally, an organic acid such as gluconic acid may also be added to adjust pH to be close to a neutral of 7, e.g., 6.8 to 7.2. This reaction may proceed for a third time period and be temperature controlled to an elevated temperature of e.g., 40° C. to 95° C., such as 50° C. to 90° C., or 60° C. to 80° C. The third time period may be, e.g., 0.5 to 24 hours, such as 0.75 to 5 hours, or 1 to 3 hours.

After this the reaction mixture undergoes isolation (removal of an oil-product layer) and purification steps (e.g., washing) to arrive at the substituted triphenyl phosphate ester composition. Commercially viable yields of above 75%, such as 80 to 98%, or 85 to 95% are achievable.

The stoichiometric ratio of the p-tert-butyl phenol to POCl₃ used in the process is ≥1.65:1, such as, for example, 1.75:1 to 2.5:1, 1.85:1 to 2.1:1, or 1.9:1 to 2.0:1. As shown in the Examples, this molar ratio along with the addition order of alkyl-substituted phenol and POCl₃ affects the end product to control the TPP %.

It should be understood that other substituted phenols can be utilized instead of p-tert-butyl phenol in the method. These include phenols substituted with the groups R3 and/or R4 as defined above. That is, these groups may be independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof. The C1-C10 alkyl groups, C1-C10 alkenyl groups, C1-C110alkoxy groups, C1-C10 hydroxyalkyl groups, can be selected from, e.g., C2-C9, C3-C7, or C4 to C6.

### EXAMPLES

### Examples 1 and 2 and Comparative Examples 1 and 2

In Example 1, a first 2-ethylhexyl diphenylphosphate ester was synthesized as follows.

### Step I.

To a 1-L flask was charged phosphorus oxychloride (153.3 g, 1.00 mol) and it was cooled to 10° C. Under vacuum, to the flask was added 2-ethylhexanol (143.3 g, 1.10 mol) at a rate to maintain the temperature below 15° C. Under 30-50 mmHg of vacuum, the mixture was held and agitated for 30 minutes to allow sufficient reaction of 2-ethylhexanol and phosphorus oxychloride at <=15 degree C., it was then warmed to 35° C. and held for 1.5 hours while under vacuum. Vacuum was broken and the dichloridate was transferred to an addition funnel.

### Steps II/III.

In another 1-L flask, water (167 g) and 50% NaOH (166.4 g, 2.08 mol) were mixed and cooled to 20° C. To this caustic solution was added phenol (189.2 g, 2.01 mol) such that the temperature was controlled under 40° C. After the resulting sodium phenate solution was cooled to 20° C., the above dichloridate (weighed 254 g) was added while maintaining 25° C. It took 30 minutes to complete this addition. The mixture was stirred at 22 to 25° C. for 45 minutes.

### Initial Isolation.

The reaction mix was diluted with water, and 38% HCl (16 g) was added to adjust pH to 10-11. After agitating at 25° C. for 5 minutes, the mixture was allowed to settle and phases to separate: the lower layer is aqueous; the upper layer is the product. The lower aqueous layer is removed to obtain the upper product layer.

### Washing Steps.

Thereafter, the oily product was subjected to a series of six washes with the second wash being a base wash using sodium hydroxide (170 gram) and the rest being water washes. After each phase, the mixture was allowed to settle and the aqueous layer was removed.

### Steam Stripping Steps.

In the 1-L flask, the washed oil was steam stripped at 120-130° C. under 80-110 mmHg of vacuum for 15 minutes. The steam was then turned off, and the content was dried at 120-130° C. under 30-50 mmHg of vacuum for 5 minutes. After the content was cooled to 80° C., vacuum was broken. 329 g of product was obtained.

Composition of the product was analyzed and 2-ethylhexyl diphenyl phosphate is 90.96%, and triphenyl phosphate is 0.022%, well below 0.1%.

Another example (Example 2) and a comparative example (Comparative Example 1) were tried using the same process steps outline in Example 1. Product compositions (by GC) of these reactions and a commercial product (Comparative Example 2) made at the production site are summarized in the table below.

Table 1 shows the reaction conditions, yield, product distribution by GC area and TPP content of Examples 1 and 2, and Comparative Examples 1 and 2.

TABLE 1

| | | | | Comparative |
|---|---|---|---|---|
| | | | Comparative | Example 2 |
| | Example 1 | Example 2 | Example 1 | Santicizer ® 141 |
| Step I: | 1.10 | 1.15 | 1.05 | 1.02 |
| 2-ethylhexanol | | | | |
| to POCl₃ mole | | | | |
| ratio | | | | |
| Hold time at | 30 | 30 | 30 | 4 |
| end of Step 1 | | | | |
| reaction (min) | | | | |
| Yield (%) | 90.8 | 91.1 | 90.5 | N/A |
| 2-Ethylhexyl | 90.96 | 87.62 | 94.67 | 93.35 |
| Diphenyl | | | | |
| Phosphate | | | | |
| (wt %) | | | | |
| TPP (wt %) | 0.022 | 0.017 | 0.200 | 0.705 |

In the Comparative Example 1, where the mole ratio of 2-ethylhexanol to POCl3 is 1.05 and the holding time at the end of step 1 was 30 minutes the TPP % of the final composition is 0.200%, above the threshold of 0.1%. This indicates that by only increasing the hold time to 30 minutes at the end of step 1 reaction and increasing mole ratio of alcohol to POCl₃ to 1.05 it is not sufficient to decrease the TPP % to be <0.1%.

In the Comparative Example 2, a production sample of Santicizer® 141 (2-ethylhexyl diphenyl phosphate) is included and the mole ratio of alcohol to POCl₃ is 1.02 and hold time at end of Step 1 reaction is 4 minutes. TPP % in this case is 0.705%, much higher than the 0.1% threshold.

### Example 3 and Comparative Examples 3 and 4

In Example 3 a first isodecyl diphenyl phosphate was synthesized as follows.

### Step I.

To a 1-L flask was charged phosphorus oxychloride (140.0 g, 0.913 mol) and it was cooled to 10° C. Under vacuum, to the flask was added isodecanol (160.0 g, 1.004 mol) at a rate to maintain the temperature below 15° C. Under 30-50 mmHg of vacuum, the mixture was held and agitated for 30 minutes to allow sufficient reaction between isodecanol and phosphorus oxychloride, and then warmed to 35° C. in 30 minutes, and it was held at 35° for 1.5 hours. Vacuum was broken and the dichloridate was transferred to an addition funnel.

### Steps II/III.

In another 1-L flask, water (152 g) and 50% NaOH (152.0 g, 1.900 mol) were mixed and cooled to 20° C. To this caustic solution was added phenol (172.7 g, 1.835 mol) such that the temperature was controlled under 40° C. After the resulting sodium phenate solution was cooled to 20° C., the above dichloridate (weighed 254 g) was added while maintaining 25° C. It took 27 minutes to complete this addition. The mixture was stirred at 22 to 25° C. for 45 minutes.

### Initial Isolation.

The reaction was diluted with water (200 g), and 38% HCl (16 g) was added to adjust pH to 10-11. After agitating at 25° C. for 5 minutes, the mixture was allowed to settle and phases were separated: the lower layer is aqueous; the upper layer is the product. The bottom aqueous layer is removed to obtain the product layer.

### Washing Step.

The oily product was subject to six washes with the 2nd one being a base wash using sodium hydroxide, all other give were water washes. In each wash, the mixture was allowed to settle and phase separate. The aqueous layer was removed.

### Steam Stripping.

In the 1-L flask, the washed oil was steam stripped at 120-130° C. under 80-110 mmHg of vacuum for 15 minutes. The steam was then turned off, and the content was dried at 120-130° C. under 30-50 mmHg of vacuum for 5 minutes. After the content was cooled to 80° C., vacuum was broken. 321 g of the product was obtained.

TPP % of the product was tested to be 0.0287% (287 ppm), well below 0.1% threshold.

A comparative example (Comparative Example 3) was tried using the same process steps outline in Example 3. Product compositions (by GC) of these reactions and a commercial product (Comparative Example 4) made at the production site are summarized in the table below:

Table 2 shows the reaction conditions, yield and product distribution by GC area of Example 3, Comparative Example 3, and Comparative Example 4 (production sample).

TABLE 2

| | | | Comparative |
|---|---|---|---|
| | | Comparative | Example 4 |
| | Example 3 | Example 3 | Santicizer ® 148 |
| Step I: Isodecanol to POCl3 | 1.10 | 1.10 | 1.05 |
| mole ratio | | | |
| Hold time at end of Step 1 | 30 | 4 | 4 |
| reaction (min) | | | |
| Yield (%) | 90.0 | 89.7 | Not Available |
| Isodecyl Diphenyl | 85.42 | 90.35 | 91.18 |
| Phosphate (wt %) | | | |
| TPP (wt %) | 0.0287 | 0.400 | 0.673 |

In Comparative Example 3, the mole ratio between alcohol and POCl3 is at 1.10. However, the hold time at the end of Step 1 reaction was only 4 minutes at about 15° C. The TPP % is 0.4%, which is still far higher than the 0.1% threshold. On the other hand, one can see that the production sample of Santicizer® 148 (isodecyl diphenyl phosphate) had 1.05 ratio and a 4 minute hold at the end of reaction 1, and it had 0.673% TPP. This demonstrated that the ratio between alcohol to POCl₃ at >=1.10 and the hold time at the end of step 1 reaction extended at about 15° C. combine to give sufficient time for POCl₃ molecules to become the mono-ester (namely, dichloridate).

### Example 4 and Comparative Examples 5 and 6

Under 50 to 250 torr of vacuum, to phosphorus oxychloride (120.0 g) was added the alcohol (mixture of lauryl and tetradecyl alcohol) (164.0 g) at 10-15° C. Under 30-50 torr of vacuum, the mixture was held and agitated at 15° C. for 30 minutes and then at 35° C. for 1.5 hours to give the intermediate as a liquid. While maintaining the temperature at 20 to 25° C., this intermediate was added to a phenate solution, which had been prepared with 25% NaOH (262 g) and phenol (147.3 g), prepared according to step 2 of Example 1. The mixture was stirred at 22 to 25° C. for 45 minutes at pH>13.

The reaction was diluted with water (180 g), and the product oil was isolated (375 g) and subjected to a series of washes, including a caustic wash, two dilute HCl washes and one water wash. The washed oil (346 g) was steam stripped and dried at 120-130° C. under vacuum to give 316 g of the C12-C16 alkyl diphenyl phosphate. Yield was 95.5%, color was 1 APHA, and acidity was 6.135 meq./100 g. GC total area for all the products was 99.39%, including 0.034% of triphenyl phosphate.

In the Comparative Example 5, the mole ratio of starting alcohols to POCl3 is 1.02 and the hold time was 30 minutes at the end of step 1 reaction.

Comparative Example 6 was as production sample of Santicizer® 2148, chemically a C12-C16 alkyl diphenyl phosphate. TPP % is 0.278% when the mole ratio of alcohol to POCl3 was 1.05 and hold time was 4 minutes.

Table 3 shows the reaction conditions, yield and product distribution by GC area of Example 4, and Comparative Example 4 and 5.

TABLE 3

| | | | Comparative |
|---|---|---|---|
| | | Comparative | Example 6 |
| | Example 4 | Example 5 | Santicizer ® 2148 |
| Step I: Alcohol to POCl3 | 1.10 | 1.02 | 1.05 |
| ratio | | | |
| Hold time at the end of | 30 | 30 | 4 |
| Step 1 reaction | | | |
| Yield (%) | 95.5 | 93.1 | 89.9 |
| Alkyl diphenyl phosphate | 87.522 | 72.91 | 88.103 |
| (wt) | | | |
| Triphenyl phosphate | 0.034 | 0.153 | 0.278 |
| content (wt %) | | | |

The data indicates that both increasing the mole ratio and increasing the hold time at end of step 1 reaction are effective of reducing TPP % to be <0.1%.

### Example 5

In Example 5, an alkyl-substituted triphenyl phosphate ester was synthesized as follows.

To a mixture of phosphorus oxychloride (153.3 g) and aluminum chloride (3.0 g), which was heated at 70° C., was charged p-tert-butylphenol (262.9 g) in portions at 70-95° C. After the mixture was further heated at 125° C. for 2 hours, phenol (117.6 g) was added in portions at 120-125° C. to the same reactor. The mixture was continued to heat at 125° C. under normal pressure for 3 hours and then under vacuum (˜50 torr) for 30 minutes. The HCl gas generated from the reaction was absorbed with water.

The reaction was cooled to 80° C. and treated with dilute base (430 g, prepared with 400 g of water and 30 g of 50% NaOH) and gluconic acid (8.0 g) at 75° C. for 1.5 hours.

Phases were separated, and the oil layer was washed three times with water until the final pH reached 8.

The washed oil (462 g) was steam stripped and dried at 120-130° C. under vacuum to give 390 g of the intended product.

The product had a yield of 91.9%, color of 55 APHA, and acidity of 0.076 meq./100 g. GC analysis of the product composition showed 0.075% of TPP, below the 0.1% threshold. The rest of the product composition included p-t-butylphenyl diphenyl phosphate, phenyl di (p-t-butylphenyl) phosphate, and some tris (p-t-butylphenyl) phosphate.

### Comparative Example 7

To a mixture of phosphorus oxychloride (153.3 g) and aluminum chloride (3.0 g), which was heated at 70° C., was charged p-tert-butylphenol (225.3 g) in portions at 70 to 95° C. After the mixture was further heated at 125° C. for 2 hours, phenol (141.2 g) was added in portions at 120 to 125° C. The mixture was continued to heat at 125° C. under normal pressure for 3 hours and then under vacuum (˜50 torr) for 30 minutes. The HCl gas generated from the reaction was absorbed with water.

The reaction was cooled to 80° C. and treated with dilute base (500 g, prepared with 460 g of water and 40 g of 50% NaOH) and gluconic acid (8.0 g) at 72° C. for 1.5 hours.

Phases were separated, and the oil layer was washed three times with water until the final pH reached 9.

The washed oil (450 g) was steam stripped and dried at 120 to 130° C. under vacuum to give 393 g of the intended product.

The product had a yield, 95.8%, color of 8 APHA, and acidity of 0.019 meq./100 g. GC analysis showed 0.15% of TPP, slightly above the threshold of 0.1%.

### Comparative Example 8

To a mixture of phosphorus oxychloride (153.3 g) and aluminum chloride (3.0 g), which was heated at 50° C., was charged p-tert-butylphenol (180.3 g) in portions at 50 to 95° C. After the mixture was further heated at 125° C. for 1.5 hours, phenol (169.4 g) was added in portions at 120-125° C. The mixture was continued to heat at 125° C. under normal pressure for 2.5 hours and then under vacuum (˜50 torr) for 30 minutes. The HCl gas generated from the reaction was absorbed with water.

The reaction was cooled to 80° C. and treated with dilute caustic (500 g, prepared with 460 g of water and 40 g of 50% NaOH) and gluconic acid (8.0 g) at 72° C. for 1.5 hours.

Phases were separated, and the oil layer was washed three times with water until the final pH reached 9.

The washed oil (404 g) was steam stripped and dried at 120-130° C. under vacuum to give 368 g of the intended product.

Yield, 93.5%. Color, 10 APHA. Acidity, 0.040 meq./100 g. GC analysis showing 1.31% of TPP, far above the 0.1% threshold.

### Comparative Example 9

To a mixture of p-tert-butylphenol (225.3 g) and aluminum chloride (3.0 g), which was heated at 105° C., was slowly charged phosphorus oxychloride (153.3 g) at 105 to 112° C. After the mixture was further heated at 115° C. for 1 hour, phenol (141.2 g) was added in portions. The mixture was continued to heat at 125° C. under normal pressure for 3 hours and then under vacuum (˜50 torr) for 30 minutes. The HCl gas generated from the reaction was absorbed with water.

The reaction was cooled to 80° C. and treated with dilute caustic (500 g, prepared with 460 g of water and 40 g of 50% NaOH) and gluconic acid (8.0 g) at 70° C. for 1.5 hours.

Phases were separated, and the oil layer was washed three times with water until the final pH reached 9.

The washed oil (423 g) was steam stripped and dried at 120-130° C. under vacuum to give 398 g of the intended product.

The product had a yield, 97.0%, a color of 55 APHA, and acidity of 0.014 meq./100 g. GC analysis showing 8.46% of TPP, quite higher than the previous two comparative examples.

All results of Example 5 and Comparative Examples 7-9 are summarized in the below Table 4.

TABLE 4

| | | Comparative | Comparative | Comparative |
|---|---|---|---|---|
| | Example 5 | Example 7 | Example 8 | Example 9 |
| Mole ratio of | 1.75 | 1.50 | 1.20 | 1.50 |
| PTBP to POCl₃ | | | | |
| Addition order | PTBP to | PTBP to | PTBP to | POCl₃ to |
| | POCl₃ | POCl₃ | POCl₃ | PTBP |
| Yield (%) | 91.9 | 95.8 | 93.5 | 97.0 |
| TPP % | 0.075 | 0.15 | 1.31 | 8.46 |

From the above results, it can be seen that in order to achieve <0.1% TPP in the intended product, the initial mole ratio of PTBP to POCl₃ should be at ≥1.65, such as ≥1.75 and the addition order is to add PTBP to POCl₃. This synergistically maximizes the chance for each POCl₃ molecule to react with PTBP to become a mono-ester first. In the Step 2 reaction in the same reactor, when phenol is added, the unreacted POCl₃ is far less. It is believed that POCl₃ reacts with phenol to become TPP, and through this approach, it controls the TPP % in the end product to be <0.1%.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. A composition comprising:
phosphate ester compounds of formula 1, formula 2, and formula 3 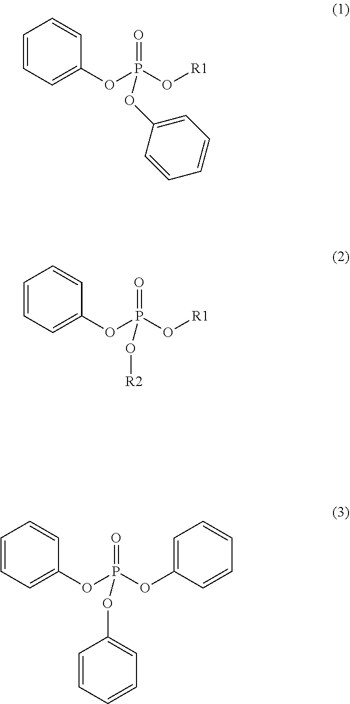
wherein R1 and R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof;
wherein formula 1 is 75% or more by weight/total weight of all phosphate esters in the composition; and formula 3 is less than 0.1% by weight/total weight of all phosphate esters in the composition;
or
phosphate ester compounds of formula 4, formula 5, and formula 3; 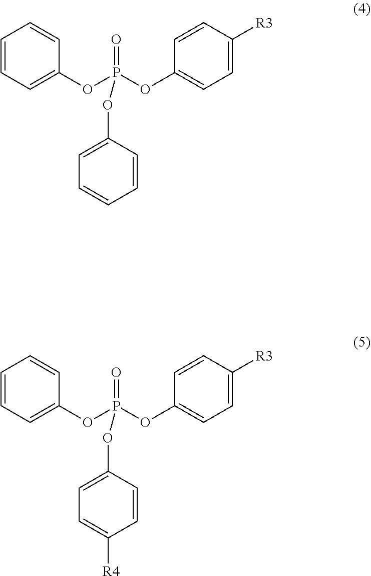
wherein R3 and R4 are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof, and formula 3 is less than 0.1% by weight/total weight of all phosphate esters in the composition.

2. The composition of claim 1, wherein R1 and R2 are independently selected from branched or linear C4-C18 alkyl groups or branched or linear C4-C18 alkylether groups; or
wherein R4 and R5 are independently selected from branched or linear C4-C18 alkyl groups or branched or linear C4-C18 alkylether groups.

3. The composition of claim 1, wherein R1 and R2 are 2-ethylhexyl.

4. The composition of claim 1, wherein R1 and R2 are a linear or branched C₁₀ alkyl group.

5. The composition of claim 1, wherein R1 and R2 are independently selected from the group consisting of linear or branched —C₁₀H₂₁, —C₁₂H₂₅, —C₁₄H₂₉, or —C₁₆H₃₃ groups.

6. The composition of claim 1, wherein the structure of formula 2 is present at 20% to 1% by weight/weight of the total weight of all phosphate esters in the composition.

7. The composition of claim 1, wherein the structure of formula 3 is present at 0.01% to 0.05% by weight/weight of the total compounds.

8. The composition of claim 1, wherein R3 and/or R4 are t-butyl groups.

9. A polymer composition comprising:
(a) a polymer selected from the group consisting of polyvinylchloride (PVC), polyurethane, polyvinyl acetate, polyvinyl butyral, polystyrene, nitro-cellulose, nitrile rubber, ABS, polycarbonate, polyamide, polyester, epoxy, and combinations thereof; and
(b) a phosphate ester composition comprising
phosphate ester compounds of formula 1, formula 2, and formula 3 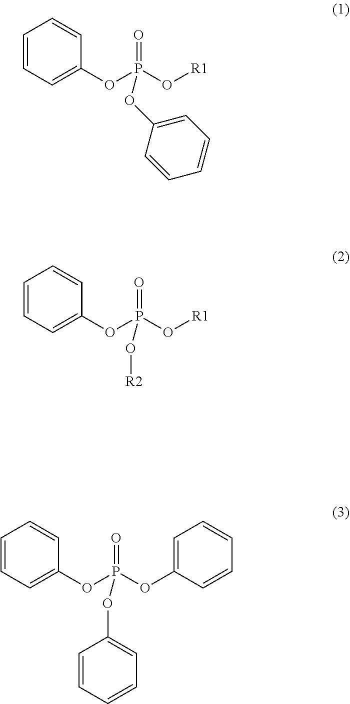
wherein R1 and R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof;
wherein formula 1 is 75% by weight/total weight of all phosphate esters in the composition; and formula 3 is less than 0.1% by weight/total weight of all phosphate esters in the composition;
or
phosphate ester compounds of formula 4, formula 5, and formula 3; 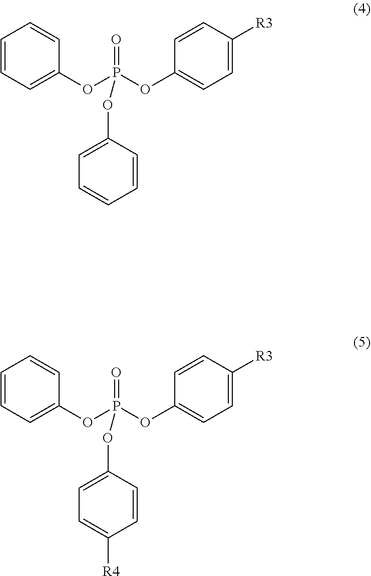
wherein R3 and R4 are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof, wherein formula 3 is less than 0.1% by weight/total weight of all phosphate esters in the composition.

10. The composition of claim 9, wherein the polymer is selected from the group consisting of PVC and polyurethane.

11. The composition of claim 9, wherein wherein R1 and R2 are independently selected from branched or linear C4-C18 alkyl groups or branched or linear C4-C18 alkylether groups; or
wherein R4 and R5 are independently selected from branched or linear C1-C10 alkyl groups or branched or linear C1-C10 alkylether groups.

12. The composition of claim 9, wherein R1 and R2 are independently selected from the group consisting of 2-ethylhexyl, linear or branched —C₁₀H₂₁, —C₁₂H₂₅, —C₁₄H₂₉, or —C₁₆H₃₃ groups; or R3 and/or R4 are t-butyl groups.

13. A method of making a phosphate ester with low triphenyl phosphate content, the method comprising:
reacting an alcohol having the formula R₀OH with POCl₃ to produce a reaction mixture with an intermediate;
wherein the alcohol having the formula R₀OH is provided at a ratio of ≥1.10 to 1 of the POCl₃ by mole ratio;
wherein R₀ is an alkyl group selected from the group consisting of: C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof;
reacting the intermediate with a phenate compound to form a composition comprising a phosphate monoester including an alkyl group corresponding to R₀;
or
reacting a substituted phenol with POCl₃ wherein the phenol is substituted with an substitute group R₃ and/or R₄;
wherein the substituted phenol is provided at a molar ratio of ≥1.65:1 of the substituted phenol to POCl₃;
wherein R₃ and R₄ are independently selected from the group consisting of C1-C10 branched or linear alkyl groups, C1-C10 branched or linear alkenyl groups, C1-C10 branched or linear alkoxy groups, C1-C10 branched or linear hydroxyalkyl groups, branched or linear C1-C10 alkyl ether groups, or mixtures of thereof.

14. The method of claim 13, wherein the composition comprises less than 0.1% of triphenyl phosphate by weight/total weight of phosphate esters.

15. The method of claim 13, wherein after the step of reacting the alcohol having the formula R₀OH with the POCl₃, the reaction is held after all the alcohol and POCl₃ is added for more than 15 minutes prior to continuing to the step of reacting the intermediate with the phenate compound.

16. The method of claim 13, wherein after the step of reacting the alcohol having the formula R₀OH with POCl₃ the reaction is held at a temperature of 1° C. to 20° C.

17. The method of claim 13, wherein in the step of reacting the alcohol having the formula R₀OH with POCl₃ a temperature of the step is kept to 1 to 20° C.

18. The method of claim 13, wherein the step of reacting the alcohol having the formula R₀OH with POCl₃ is performed under partial vacuum or after adding the substituted phenol a partial vacuum is applied.

19. The method of claim 13, wherein the phosphate ester composition comprises phosphate ester compounds of formula 1, formula 2, and formula 3 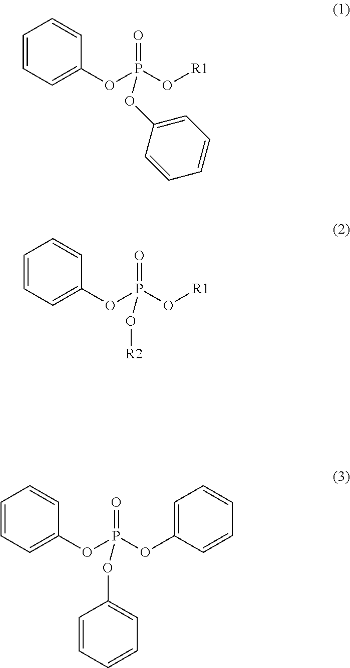
wherein R1 and R2 are independently selected from the group consisting of C4-C18 branched or linear alkyl groups, C4-C18 branched or linear alkenyl groups, C4-C18 branched or linear alkoxy groups, C4-C18 branched or linear hydroxyalkyl groups, branched or linear C4-C18 alkyl ether groups, or mixtures thereof;
wherein formula 1 is 75% by weight/total weight of the phosphate ester compounds in the composition; and formula 3 is less than 0.1% by weight/total weight of the phosphate ester compounds in the composition;
or
phosphate ester compounds of formula 4, formula 5, and formula 3; 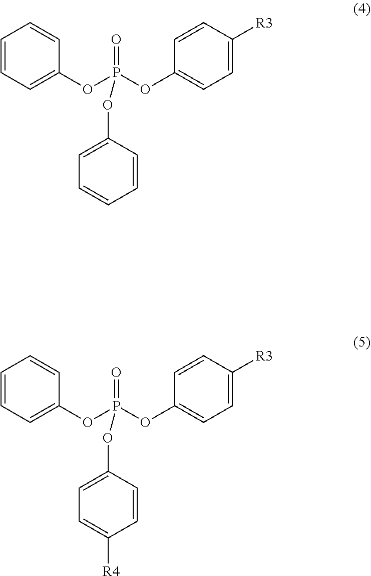
wherein formula 3 is less than 0.1% by weight/total weight of the phosphate ester compounds in the composition.

20. The method of claim 13, wherein the substituted phenol is reacted with POCl₃ and the molar ratio of substituted phenol to POCl₃ is 1.75:1 to 2.5:1; and
An order of addition is to add the substituted phenol to the POCl₃.
